(19) United States
(12) Patent Application Publication
(10) Pub. No.: US 2002/0101987 A1
(43) Pub. Date: Aug. 1, 2002

(54) Elliptic curve cryptographic methods and apparatus

(76) Inventors: Cetin K. Koc, Corvallis, OR (US); Erkay Savas, Corvallis, OR (US); Thomas A. Schmidt, Corvallis, OR (US)

Correspondence Address: One World Trade Center, Suite 1600, 121 S.W. Salmon Street, Portland, OR, 97204, US

(21) Appl. No.: 09/895,827

(22) Filed: Jun. 29, 2001

Related U.S. Application Data
(60) Provisional application No. 60/215,380, filed on Jun. 29, 2000.

(51) Int. Cl. H04L 9/00

(52) U.S. Cl. 380/44

(57) ABSTRACT

Methods for generating elliptic curves of known order over finite fields include selecting a discriminant and a class polynomial from respective sets of discriminants and class polynomials. Based on the selected values, an order of an elliptic curve is determined and the elliptic curve is specified based on a root of the class polynomial. The order of the elliptic curve is adjusted based on a twist operation. The methods are implemented in, for example, computer executable instructions stored on a computer readable medium. Elliptic curve generators based on the methods are provided as well as cryptographic systems including such generators.

### FIELD OF THE INVENTION

The invention pertains to elliptic curve cryptography.

### BACKGROUND

An important category of cryptographic systems are those using elliptic curves defined over a finite field Fₚ. For such systems to be useful in practical applications, fast elliptic curve arithmetic is necessary. While some methods for such arithmetic have been suggested, these methods typically require high precision complex and floating point arithmetic that can be difficult and expensive to implement on simple processors with limited amounts of memory. Miyaji has proposed cryptographic systems based on construction of so-called “anomalous” elliptic curves. See, for example, A. Miyaji, “Elliptic Curves over Fₚ Suitable for Cryptosystems,” in Lecture Notes in Computer Science, vol. 718 (Springer Verlag 1992). Unfortunately, cryptosystems based on such elliptic curves are generally insecure. Lenstra has suggested using restricted sets of discriminants for elliptic curve construction. See, A. K. Lenstra, “Efficient identity based parameter selection for elliptic curve cryptography,” Information Security and Privacy-ACISP '99, pp. 294-302 (1999). Unfortunately, Lenstra considers only certain special cases and improved methods for constructing elliptic curves are needed.

For convenience, some properties of elliptic curves are briefly summarized. An elliptic curve ε defined over a finite field Fₚ, wherein p>3, can be expressed as

ε(Fₚ): y²=x³+ax+b a, b ∈ Fₚ. (1)

Two quantities associated with the elliptic curve ε are a discriminant Δ and a j-invariant, defined as

Δ=−16(4a³+27b²), (2)

j=1728(4a)³/Δ, (3)

respectively, wherein Δ≢0. For a particular j₀ ∈Fₚ, there is an elliptic curve ε defined over Fₚ such that j(ε)=j₀.

An elliptic curve corresponding to a selected j-invariant j₀∈ Fₚ can be constructed as follows. For j₀ not in the range [0,1728], let k=j₀/(1728−j₀). Then an associated elliptic curve ε is given by

ε: y²=x³+3kx+2k (4)

and has a j-invariant j(ε)=j₀. Elliptic curves can also be defined for j₀ in the range [0, 1728].

Several useful theorems and definitions are set forth below.

Theorem 1 Isomorphic elliptic curves have the same j-invariant.

Theorem 2 (Hasse) Let #ε(Fₚ) denote the number of points on the elliptic curve ε(Fₚ). If #ε(Fₚ)=p+1−t, then |t|≦2\sqrt{p}.

The “twist” of an elliptic curve ε: y²=x³+ax+b with a, b ∈ Fₚ with respect to c ∈ Fₚ is an elliptic curve ε given by

ε_{c}: y²=x³+ac²x+bc³. (5)

Theorem 3 Let ε be defined over Fₚ and have order #ε (Fₚ)=p+1−t. Then the order of the twist of ε is:

$$\# {ϵ}_{c} ( {ℱ}_{p}^{*} ) = \{ \begin{matrix}p + 1 - t & if c is square in {ℱ}_{p} \\ p + 1 + t & if c is non \text{-} square in {ℱ}_{p}\end{matrix} \qquad ( 6 )$$

Theorem 4 (Atkin-Morain) Let p be an odd prime such that

4p=t²+Dₛ² (7)

for some t, s ∈ Z. Then there is an elliptic curve ε defined over Fₚ such that #ε(Fₚ)=p+1−t.

An integer D that satisfies Equation 7 for a selected p is referred to as a CM discriminant of p. Indeed, the curve ε has complex multiplication by the integers of the ring of integers Q (\sqrt{−D}). Given such a D for a prime p, the j-invariant of an associated elliptic curve can be calculated based on class field theory. After the j-invariant is determined, an elliptic curve with p+1−t points can be constructed as shown above. As noted above, the procedure produces an elliptic curve with either p+1−t or p+1+t points. If the constructed elliptic curve has p+1+t points, then the twist of this elliptic curve can be used to obtain an elliptic curve with p+1−t points.

These theorems and additional properties of elliptic curves are described in, for example, J. H. Silverman, The Arithmetic of Elliptic Curves, (Springer Verlag, 1986) and G. H. Lay and H. G. Zimmer, “Constructing elliptic curves with given group order over large finite fields,” Algebraic Number Theory, pp. 157-165 (New York, 1994).

Construction of an elliptic curve based on a selected twist can be performed using Theorem 3. This method of constructing elliptic curves of known order is referred to as the complex multiplication (“CM”) method and is described in, for example, IEEE Standard Specifications for Public-Key Cryptography, Standard 1363 (IEEE Press, 2000). The CM method is summarized below and is illustrated in FIG. 1. In a step 105, a prime number p is selected and in a step 110 t and a smallest D in Equation 7 are determined. (The quantity s is not needed). Orders of the curves are computed in a step 115 as #ε(Fₚ)=p+1±t. In a step 120, the orders #ε are checked for an admissible factorization. If one of the orders has an admissible factorization, then the computed D and t are satisfactory. If there is no admissible factorization, another D and associated t are determined in step 110 and this procedure is repeated until an order with an admissible factorization is found.

With appropriate D and t, a class polynomial H_{D}(x) is determined as specified in the P1363 standard in a step 125. A class polynomial for a selected D is a fixed monic polynomial having integer coefficients. In particular, a class polynomial is independent of p. In a step 130, a root j₀ of H_{D}(x) (mod p) is determined. The calculated j₀ is the j-invariant of the elliptic curve to be constructed. In a step 135, k is assigned a value k=j₀/(1728−j₀) (mod p), and an elliptic curve is constructed as ε: y²=x³+3kx+2k. In a step 140, the order of the curve is checked. If the order is not p+1−t, then a twist is constructed with a randomly selected nonsquare c ∈ Fₚ in a step 145. The constructed elliptic curve is returned in a step 150.

With the CM method, a prime number p is selected, and then an elliptic curve over Fₚ is constructed. This method has the potential advantage of allowing prime numbers of special forms to be used and thereby permitting more efficient modular arithmetic based on the special form of the prime numbers. However, this method is efficient only when the degree of the class polynomial is small. In general, factoring a high degree polynomial is time-consuming and the construction of the class polynomials requires multi-precision floating-point and complex number arithmetic. Therefore, improved methods and apparatus for elliptic curve construction are needed.

### SUMMARY OF THE INVENTION

Methods and apparatus are provided for construction of elliptic curves of a selected prime order. These methods and apparatus permit simple, rapid determination of such elliptic curves. According to representative methods, an elliptic curve is generated by selecting a discriminant and determining a class polynomial so that the elliptic curve is constructed based on the selected discriminant and class polynomial. In some embodiments, a set of discriminants is stored and the selected discriminant is obtained from the set of discriminants. In other methods, a set of class polynomials is stored and the selected class polynomial is obtained from the set of class polynomials. According to additional embodiments, elliptic curve construction methods include adjusting an order of a constructed elliptic curve by determining a twist of an intermediate elliptic curve.

Computer readable media are provided that include computer-readable instructions for performing elliptic curve generation based on at least one of a selected discriminant and a class polynomial.

In representative methods, a prime number is selected based on a selected discriminant and an order of a constructed elliptic curve is determined based on the prime number. According to additional examples, a class polynomial is obtained and the elliptic curve is constructed based on a root of the class polynomial.

Cryptographic processors include an elliptic curve generator configured to provide an elliptic curve based on a selected discriminant. According to representative embodiments, a discriminant memory configured to store a set of discriminants is included.

Cryptographic systems are provided that include a processor situated and configured to determine a set of discriminants and an associated set of class polynomials. In further embodiments, the processor is configured to determine an order of an elliptic curve based on a selected discriminant of the set of discriminants.

Elliptic curve generators include an input configured to receive an instruction to produce an elliptic curve and a processor that constructs the elliptic curve based on a selected discriminant. In representative examples, the processor is configured to receive the selected discriminant from a set of discriminants and includes a twist component that produces a twist of an elliptic curve.

These and other features of the invention are described below with reference to the accompanying drawings.

### BRIEF DESCRIPTION OF THE DRAWINGS

FIG. 1 is a block diagram of a method of constructing an elliptic curve based on a selected prime number p.

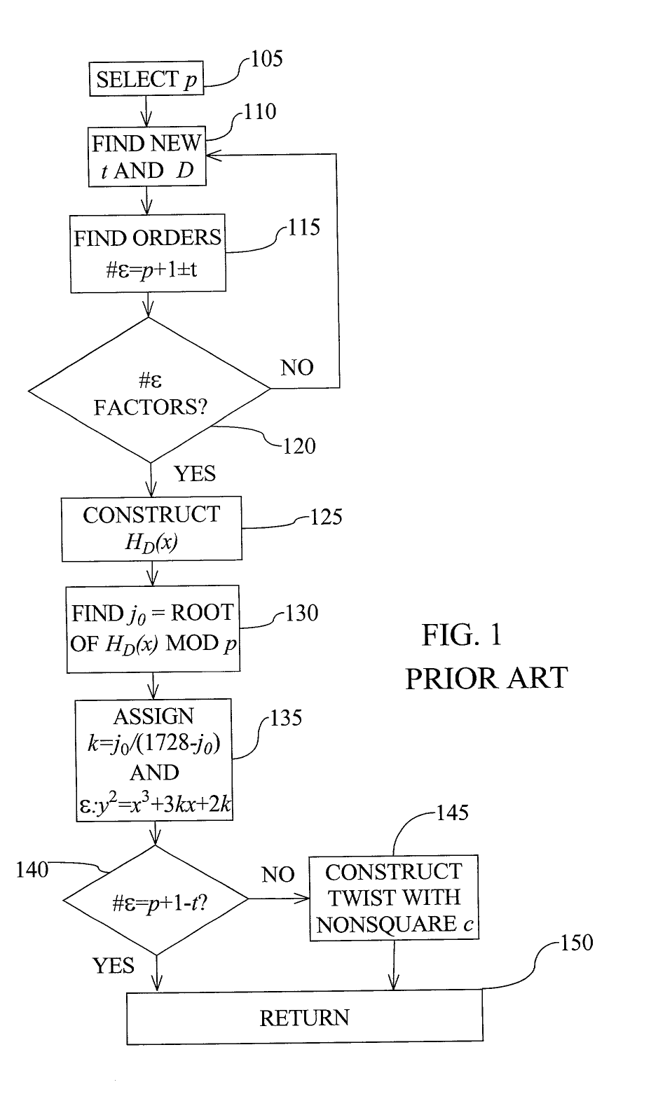

FIG. 2 is a block diagram of a method of constructing elliptic curves based on a set of discriminants.

FIGS. 3A-3C are graphs of construction time, Nₚ, and Nᵤ as a function of class number, respectively.

FIG. 4 is a graph of construction time as a function of discriminant for a bitsize of 192.

FIG. 5 is a graph of an average number of trials Nₚ needed to determine p as a function of discriminant for a bitsize of 192.

FIG. 6 is a graph of an average number of trials Nᵤ needed to determine u as a function of discriminant for a bitsize of 192.

FIG. 7 is a graph of construction time as a function of discriminant for a bitsize of 224.

FIG. 8 is a graph of is a graph of an average number of trials Nₚ needed to determine p as a function of discriminant for a bitsize of 224.

FIG. 9 is a graph of an average number of trials Nᵤ needed to determine u as a function of discriminant for a bitsize of 224.

FIG. 10 is a graph comparing theoretical and experimental values of a product Nₚ×Nᵤ as a function of discriminant.

FIG. 11 is a block diagram of a cryptographic processor that includes an elliptic curve generator.

### DETAILED DESCRIPTION

According to a representative method, class polynomials for discriminants D in a set D are constructed and stored. Prime numbers are searched for that have CM discriminants in this set. Repeated calculation of class polynomials is avoided and delays associated with multi-precision floating point arithmetic, complex number arithmetic, and factorization of high degree class polynomials are avoided. Such methods are practical, even for class polynomials of large degree.

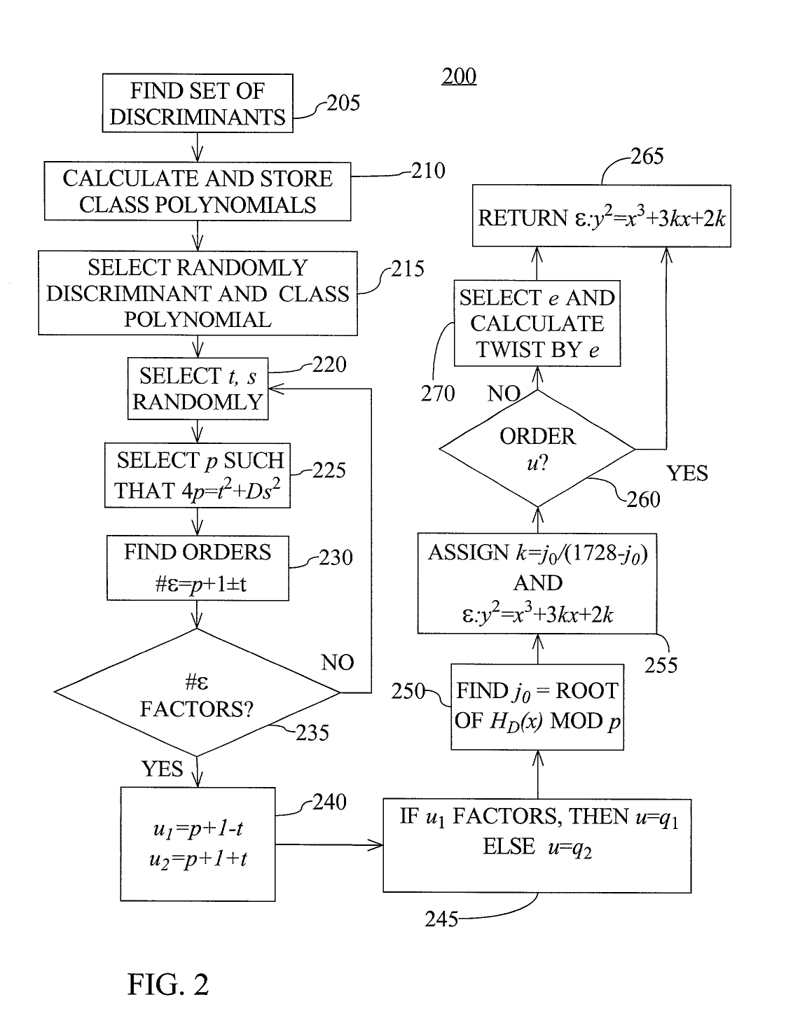

A representative example of such a method is illustrated in FIG. 2. The method 200 includes the step 205 of determining a set D of CM discriminants such that corresponding class numbers are small. In a step 210, class polynomials associated with CM discriminants in D are calculated and stored. The steps 205, 210 can be performed prior to a demand for elliptic curve construction so that associated execution delays are avoided. In a step 215, a CM discriminant D in D is randomly selected and a corresponding class polynomial H_{D}(x) is determined. In a step 220, random values of t and s values of appropriate sizes are selected. In a step 225, a prime number p is selected based on 4p=t²+Ds², and the resulting value of p is checked to verify that p is prime.

In a step 230, orders u₁=p+1−t and u₂=p+1+t of potential elliptic curves are calculated. In a step 235, the orders u₁, u₂ are tested to determine if either has an admissible factorization (i.e. is a prime or nearly-prime number). If there is no admissible factorization, steps 220, 225, 230, 235 are repeated. If u₁ has proper factorization, then u=q₁, otherwise u=q₂.

In a step 250, a j-invariant of an elliptic curve is determined as a root j₀ of H_{D}(x) mod p. In a step 255, k is assigned a value k=j₀/(1728−j₀) mod p and an elliptic curve of order u₁ or u₂ is constructed as

ε_{c}: y²=x³+ax+b (8)

wherein a=3kc², b=kc³, and c ∈ Fₚ is randomly chosen. In a step 260, an order of the elliptic curve is computed. If the order is u, then the elliptic curve is returned in a step 265. If the order is not u, then in a step 270 a nonsquare number e ∈ Fₚ is selected and a twist εₑ(Fₚ)=x³+ae²+be³ by e is calculated. Using the method 200, pairs p and u can be found quickly.

### Constructing Class Polynomials

Various methods are available for the calculation of class polynomials that is performed in step 210. As representative examples, methods are described in A.O.L. Atkin and F. Morain, “Elliptic curves and primality proving,” Mathematics of Computation 61:29-68 (1993) and D. A. Cox, Primes of the Form x²+ny²: Fermat, Class Field Theory and Complex Multiplication, John Wiley & Sons (New York, 1989).

A representative example uses a discriminant D of a quadratic form f(x,y)=ax²+bxy+cy², wherein a, b, c are integers and D=b²−4ac. The quadratic form f(x,y) can be represented compactly using the notation [a,b,c]. If the integers a, b, c have no common factor, then the quadratic form [a,b,c] is referred to as primitive. There are infinitely many quadratic forms associated with a discriminant and these can be reduced to a finite number by requiring that a root of f(x,1) be in a selected region of a complex plane. Let the primitive quadratic form [a,b,c] be of negative discriminant and τ be a root of f(x,1) in the upper half-plane:

τ=(−b+\sqrt{D})/2a.

Then [a, b, c] is a reduced form if τ has complex norm greater than or equal to 1, and Re(τ) ∈[−½, ½]. Given a discriminant D<0, the reduced quadratic forms of discriminant D can be found. The class polynomial H_{D}(x) (i.e., the minimal polynomial of j(τ)) is then determined. For each value of τ, the associated j-value (denoted jᵢ below) can be computed as follows:

j(\sqrt{D})=(256f(τ)+1)³/f(τ)

wherein

f(τ)=Δ(2τ)/Δ(τ),

$$Δ ( τ ) = q \cdot {[ 1 + {\sum }_{n \geq 1} {( - 1 )}^{n} ( {q}^{3 n ( n + 1 / 2} + {q}^{3 n ( n - 1 / 2} ) ]}^{24} , and$$

q=e^{2πiτ.}

Finally, the class polynomial can be constructed by using the formula:

$${H}_{D} ( x ) = {\prod }_{i = 1}^{h} ( x - {j}_{i} )$$

wherein h is a number of the reduced forms of D, commonly known as the class number of D and jᵢ are the j-values associated with respective roots. Since H_{D}(x) has integer coefficients, computations involving H_{D}(x) must retain sufficient numbers of integer digits.

Class polynomials are calculated and stored for given D values. Such calculations can be done with software tools for general mathematical analysis such as, for example, MAPLE or MATHEMATICA. Alternatively, specialized number theoretical software can be used such as, for example, V. Shoup, “NTL: A Library for Doing Number Theory”. For many applications, software is conveniently provided as a series of programming instructions in a programming language such as C, C++, BASIC, assembly language, or other programming language. Floating point arithmetic precision is adjusted so that the precision is approximately:

$$\begin{matrix}precision = 10 + ( \begin{matrix}h \\ ⌊ h / 2 ⌋\end{matrix} ) \cdot π \sqrt{D} \cdot {\sum }_{i = 1}^{h} 1 / {a}_{i} , \\ N = 10 + ( \begin{matrix}h \\ ⌊ h / 2 ⌋\end{matrix} ) \cdot {\sum }_{i = 1}^{h} 1 / {a}_{i} .\end{matrix}$$

wherein N is a number of terms to retain in calculations involving various Δ(τ).

Methods other than the use of the j-function can be employed to construct class polynomials. In these methods, a class-invariant polynomial is obtained for the CM discriminant D. One advantage of using different methods is that class polynomials with relatively small integer coefficients can be obtained. This can be particularly important when the processor used to store polynomial coefficients has limited memory.

### Representative Implementation Results

As an example, the method of FIG. 2 was implemented using the NTL number theory and algebra package on a 450-MHz Pentium II based personal computer running a MICROSOFT WINDOWS NT operating system. Values of the parameters t and s were restricted to t=2v+1 and s=2w+1 wherein v, w ∈ Z. Thus, the prime numbers found in this manner are of the form

$$p = {v}^{2} + v + ( {w}^{2} + w ) D + \frac{D + 1}{4} \qquad ( 9 )$$

wherein D satisfies

D≡3 (mod 4).

Furthermore, D was selected so that (D+1)/4 was odd, so that p was odd for any choice of v and w. The value D=3 was excluded and the imaginary quadratic field of exceptionally many units was avoided. Average computation times were obtained for finding the prime p and prime u as well as for calculation of the associated elliptic curve for D={163, 403, 883}. If u were merely required to be a nearly prime number, the search times for admissible pairs would have decreased. For these values of D, the corresponding class polynomials are:

H₁₆₃(x)=x+640320;

H₄₀₃(x)=x²−108844203402491055833088000000 x

+2452811389229331391979520000;

H₈₈₃(x)=x³+167990285381627318187575520800123387904000000000 x²

−151960111125245282033875619529124478976000000 x

+34903934341011819039224295011933392896000.

For the class number one, the class polynomial is of degree one and the root was obtained without additional computation. To find a root modulo-p of class polynomials for other classes requires an approximately constant time determined by the size of the modulus p and the degree of the polynomial. For the two other polynomials listed above, a root for each p of the quadratic or cubic polynomial, respectively, was obtained. Estimation of the time or number of trials needed to find admissible pairs p, u is more complex than estimation of times required to find roots. Table 1 contains construction times required to construct elliptic curves of known prime order.

TABLE 1
Construction times for construction of elliptic curves
of known prime order.

| D | class no | bitsize | Average time (s) | Nₚ | Nᵤ |
|---|---|---|---|---|---|
| 163 | 1 | 192 | 1.22 | 23 | 11 |
| 163 | 1 | 224 | 2.29 | 27 | 14 |
| 403 | 2 | 192 | 1.57 | 30 | 14 |
| 403 | 2 | 224 | 3.29 | 36 | 21 |
| 883 | 3 | 192 | 1.63 | 30 | 14 |
| 883 | 3 | 224 | 3.01 | 36 | 19 |

The data of Table 1 are based on an average produced by obtaining 1000 different curves with each value of D. In Table 1, Nₚ is an approximate number of random pairs of v and w that must be tried before a prime p=v²+v+(w²+w)D+(D+1)/4 is found. Similarly, Nᵤ is an average number of p of the form of Equation 9 that must be tried to obtain a prime u.

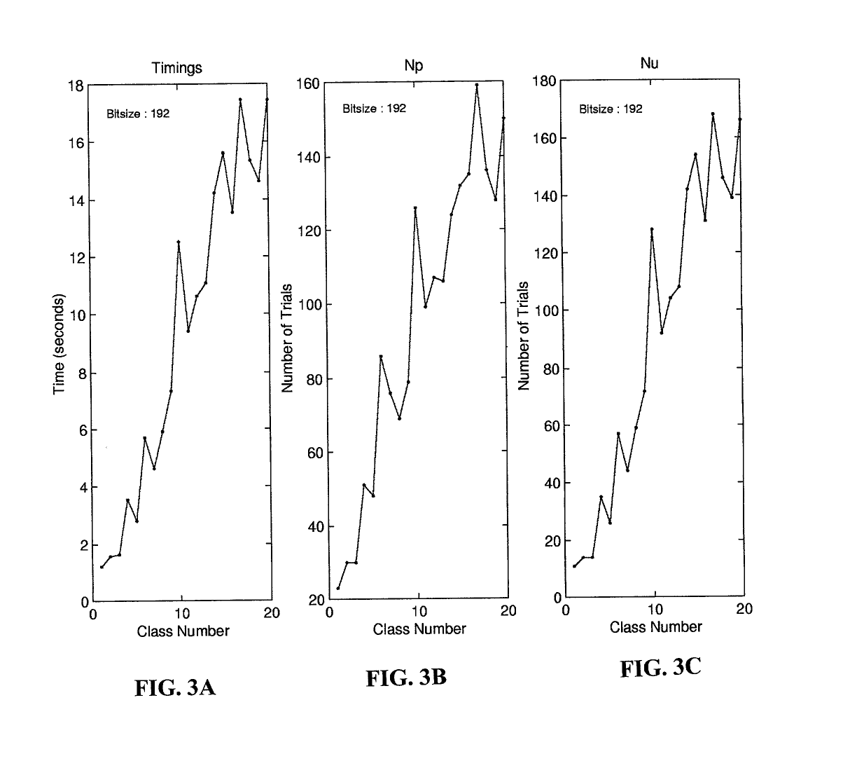

The method 200 remains efficient for larger class numbers, as shown in Table 2. FIGS. 3A-3C are graphs of elliptic curve construction time, Nₚ, and Nᵤ, respectively, as a function of class number for a bit-size of 192 bits.

TABLE 2
Time required to construct elliptic curves of prime order for
large class numbers.

| bitsize | D | class no | Average time (s) | Nₚ | Nᵤ |
|---|---|---|---|---|---|
| 192 | 555 | 4 | 3.54 | 51 | 35 |
| | 1051 | 5 | 2.78 | 48 | 26 |
| | 451 | 6 | 5.70 | 86 | 57 |
| | 811 | 7 | 4.61 | 76 | 44 |
| | 1299 | 8 | 5.91 | 69 | 59 |
| | 1187 | 9 | 7.35 | 79 | 72 |
| | 611 | 10 | 12.53 | 126 | 128 |
| | 1283 | 11 | 9.42 | 99 | 92 |
| | 1235 | 12 | 10.62 | 107 | 104 |
| | 1451 | 13 | 11.08 | 106 | 108 |
| | 1211 | 14 | 14.22 | 124 | 142 |
| | 1259 | 15 | 15.61 | 132 | 154 |
| | 1379 | 16 | 13.54 | 135 | 131 |
| | 1091 | 17 | 17.46 | 159 | 168 |
| | 1691 | 18 | 15.35 | 136 | 146 |
| | 2099 | 19 | 14.64 | 128 | 139 |
| | 1739 | 20 | 17.45 | 150 | 166 |
| | 25259 | 72 | 23.20 | 140 | 160 |
| | 37571 | 95 | 24.90 | 152 | 157 |

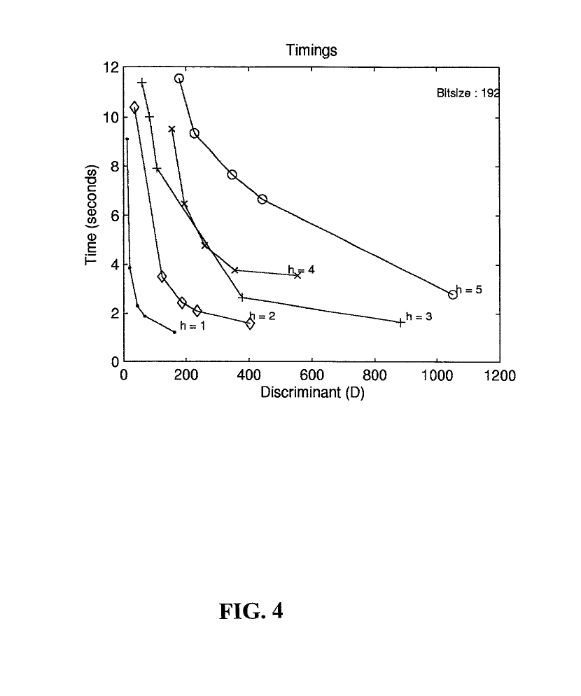

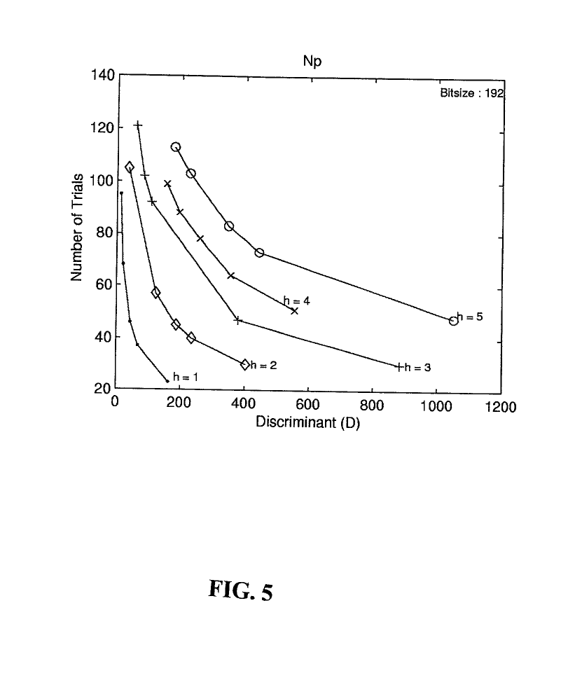

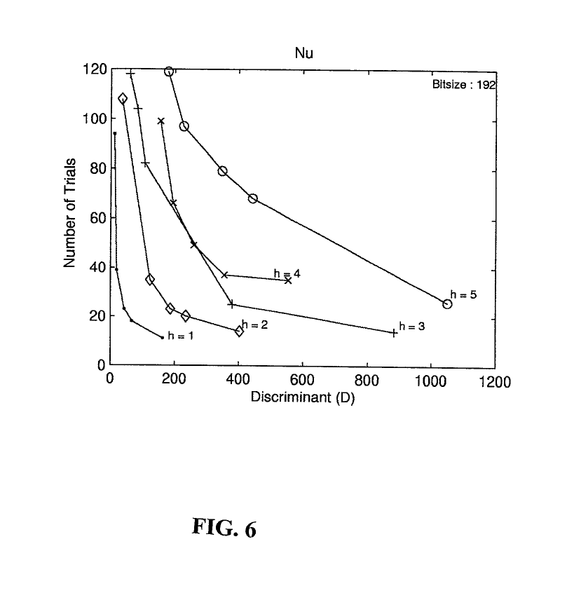

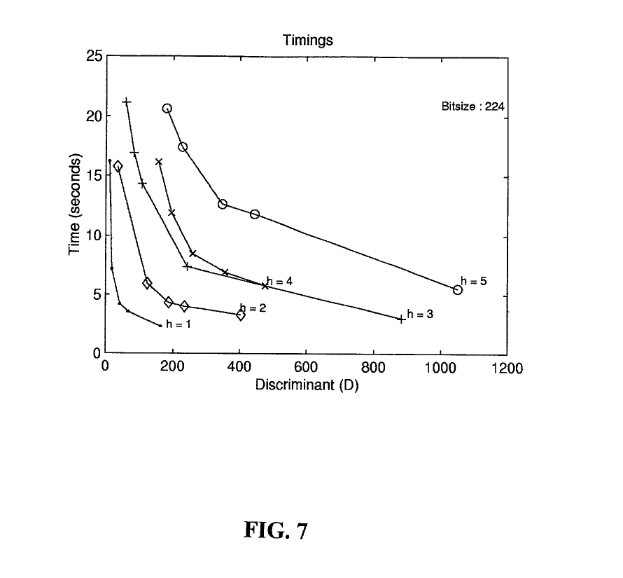

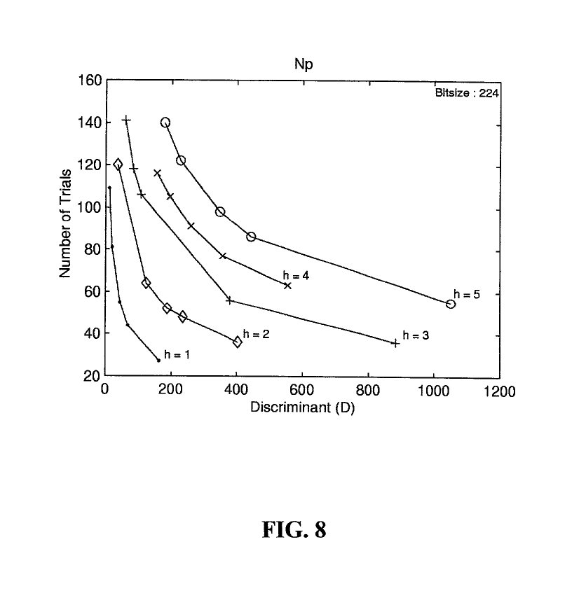

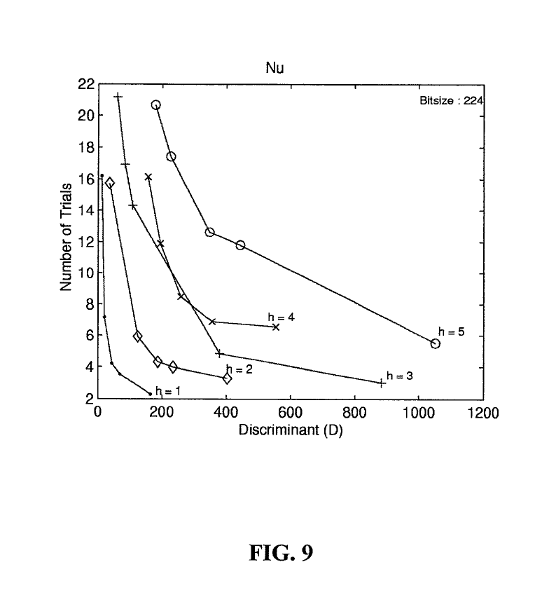

Table 2 demonstrates that the admissible pair search time increases with the class number. Although this increase is not monotonic—the timing for class number 10 is higher than those for class numbers 11, 12, and 13—it is likely that the approximate time needed to find such pairs is proportional to the class number. The dependence of the construction process on the particular value of D probably produces deviations from monotonicity. The time to find an admissible pair (p,u) generally decreases with the size of D. Table 3 contains times for various class numbers and values of Nₚ and Nᵤ. FIGS. 4-9 are additional graphs illustrating performance of the method 200.

TABLE 3
Construction times for various class numbers.

| | | bitsize 192 | | | bitsize 224 | | |
|---|---|---|---|---|---|---|---|
| field type | | Average | | | Average | | |
| class no | D | time (s) | Nₚ | Nᵤ | time (s) | Nₚ | Nᵤ |
| 1 | 11 | 9.10 | 95 | 94 | 16.20 | 109 | 113 |
| | 19 | 3.86 | 68 | 39 | 7.15 | 81 | 49 |
| | 43 | 2.30 | 46 | 23 | 4.19 | 55 | 28 |
| | 67 | 1.87 | 37 | 18 | 3.55 | 44 | 23 |
| | 163 | 1.22 | 23 | 11 | 2.29 | 27 | 14 |
| 2 | 35 | 10.38 | 105 | 108 | 15.74 | 120 | 110 |
| | 123 | 3.49 | 57 | 35 | 5.93 | 64 | 40 |
| | 187 | 2.42 | 45 | 23 | 4.31 | 52 | 28 |
| | 235 | 2.09 | 40 | 20 | 3.98 | 48 | 26 |
| | 403 | 1.57 | 30 | 14 | 3.29 | 36 | 21 |
| 3 | 59 | 11.37 | 121 | 118 | 21.17 | 141 | 128 |
| | 83 | 10.01 | 102 | 104 | 16.93 | 118 | 117 |
| | 107 | 7.90 | 92 | 82 | 14.33 | 106 | 99 |
| | 379 | 2.63 | 47 | 25 | 4.85 | 56 | 32 |
| | 883 | 1.63 | 30 | 14 | 3.01 | 36 | 19 |
| 4 | 155 | 9.50 | 99 | 99 | 16.14 | 116 | 112 |
| | 195 | 6.46 | 88 | 66 | 11.90 | 105 | 82 |
| | 259 | 4.77 | 78 | 49 | 8.46 | 91 | 58 |
| | 355 | 3.76 | 64 | 37 | 6.87 | 77 | 46 |
| | 555 | 3.54 | 51 | 35 | 6.54 | 63 | 44 |
| 5 | 179 | 11.54 | 113 | 119 | 20.65 | 140 | 142 |
| | 227 | 9.33 | 103 | 97 | 17.42 | 122 | 120 |
| | 347 | 7.64 | 83 | 79 | 12.64 | 98 | 86 |
| | 443 | 6.65 | 73 | 68 | 11.81 | 86 | 81 |
| | 1051 | 2.78 | 48 | 26 | 5.52 | 55 | 36 |

In additional to execution speed, code size can be an important practical consideration. One implementation of the CM method, described in M. Scott, “A C++ implementation of the complex multiplication (CM) elliptic curve generation algorithm from Annex A,” (2000), uses 204 KB on a PC running MICROSOFT WINDOWS NT. An example implementation of the method 200 using NTL required only a 164 kB code space. Code space can be made much smaller when dedicated code is written for curve generation. As an example, a program treating only the class number one case was written and required about 10 kB additional code space for curve generation.

### Twin Primes and Prime Order Elliptic Curves Finding Primes

The Prime Number Theorem states that for a sufficiently large number M, the number of primes in [2, M] is approximately M/1n M. But, with D as chosen above, 4p=t²+s²D expresses that p is a norm of an element in the ring of integers Q(\sqrt{−D}). The density of rational primes of this type is 1/(2h_{D}), wherein h_{D} is the class number of Q(\sqrt{−D}). See, for example, H. Cohn, Advanced Number Theory (Dover Publications, New York, 1980) and Primes of the Form x²+ny² cited above. There are approximately M/(2h_{D} 1n M) primes of size up to M available.

With p≦M, each pair (s,t) ∈ Z² gives an integral lattice point inside the ellipse of equation t²+s²D=M/4. An asymptotic formula for the number of lattice points interior to an ellipse is given in, for example, Advanced Number Theory cited previously. Thus, the number of the lattice points (s, t) with s, t both positive is L(M)=π(M)\sqrt{D}+O(\sqrt{M}). Furthermore, since p is odd, odd D are used and the elliptic curve order u=p+1±t is to be prime (hence odd). Thus s and t are odd and L(M)/4 distinct values of t²+s²D are searched for (s,t) interior to the ellipse.

The prime p is to be in a specific range of the form [S,2S], and hence is expected to be found after a total number of trials of (v,w) of about \overline{N}ₚ: =c(πh_{D} 1n S)/\sqrt{D}, for some constant c. Our experimental data confirms this as shown in Tables 1-3, wherein S is either 2¹⁹¹ or 2²²³.

### Prime Order Elliptic Curves and Twin Primes

The order of the elliptic curve to be constructed is u=p+1±t, wherein u is prime. The prime p is the norm of the element P=(t+s\sqrt{−d})/2 and t is the trace of P. The norms of P±1 are easily seen to be the two possibilities for u. Thus, twin pairs (P, P±1) are to be found. The theory of complex multiplication ensures that associated with each pair of this form is an elliptic curve defined over Fₚ, wherein p is the norm of P and whose exact number of points over this field equals the norm of P±1.

Although it is not known if there are infinitely many twin prime (principal ideal) pairs in any quadratic field, there are conjectures as to their numbers within bounded regions. This is also the case for twin rational primes, for which it has been conjectured that there are some C₂ ∫₂^{M} 1/(1n y)² dy twin primes of size less than M, with C₂=2 Π_{odd prime p} 1−1/(p−1)². This constant is approximately 1.32032. The integral ∫₂^{M} 1/(1n y)² dy is M/(1n M)²x γ(M), where γ(M) is (1+2!/(1n M)²+. . . +n!(1n M)ⁿ⁻¹)+0((1n M)ⁿ⁻¹).

General conjectures for the number of twin primes in algebraic number fields have been given. See, for example, R. Gross and J. H. Smith, “A generalization of a conjecture of Hardy and Littlewood to algebraic number fields,” Rocky Mountain J. Math 30:195-215 (2000). For Q(\sqrt{−D}) with D congruent to 3 modulo 8, one conjecture is that the number of twin primes of norm less than M is P(D, M)=2\sqrt{D}/(πh_{D}²)×β(D)×∫₂^{M} 1(1n y)²dy, with β(D)=Π_{Q} (1−1/(N(Q)−1))² where Q runs through the prime ideals of Q(\sqrt{−D}) and N (Q) denotes the norm to Z. Thus, the number of pairs (v,w) that produce elliptic curves of 2\sqrt{D})/(πh_{D}²)×M/(1n M)²×β(D)×γ(M).

β(D) for D congruent to 3 modulo 8 can be bounded by considering (unachievable external splitting behavior of rational prime ideals (p). Were every odd prime to split as the product of two distinct primes to such a field, then βₛₚₗᵢₜ=2/9×C₂²=0.3874 . . . . If all odd primes were to remain inert, βᵢₙₑᵣₜ=0.87299.

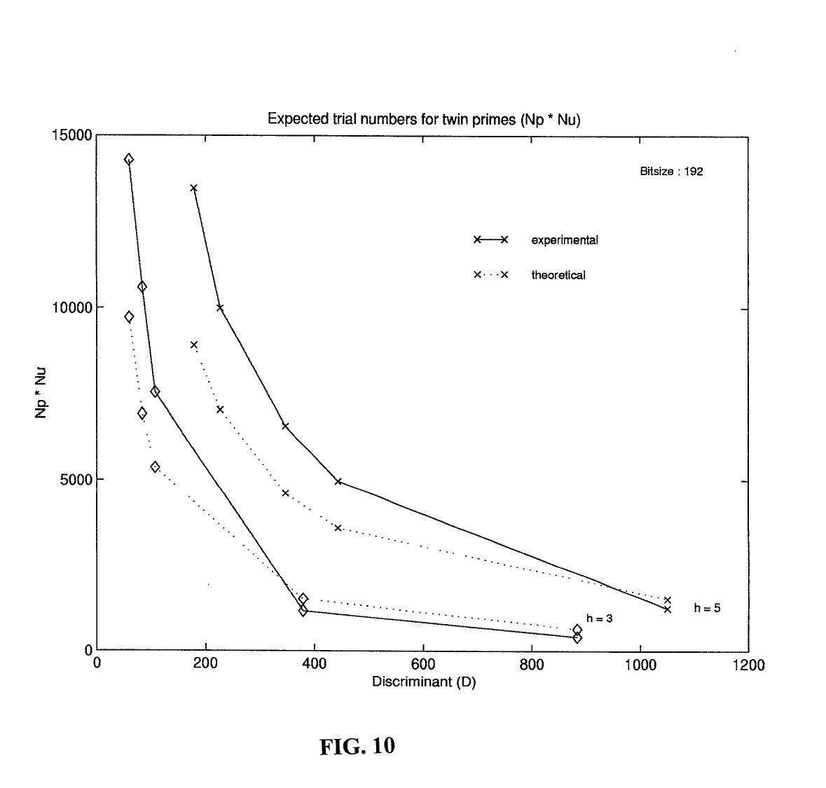

Thus, the number of trials of pairs (v, w) to find a prime pair (p, u) with p of norm in an interval [S, 2S] should be about \overline{N}ₚx\overline{N}ᵤ with \overline{N}ᵤ approximately a constant times h_{D} 1n S/β(D)\sqrt{D}. FIG. 10 confirms this estimate.

### Special Case: Class Number One

A reduction of an equation over the integers Z with respect to a prime number p is obtained by reducing each coefficient of the equation modulo-p. This can be extended to equations of the rational numbers and to equations over algebraic number fields, where one reduces by prime ideals.

Koblitz has derived conjectures for the number of primes p for which the reduction of an elliptic curve defined over Q is an elliptic curve of prime order. See, for example, N. Koblitz, “Primality of the number of points on an elliptic curve over a finite field,” Pacific J. Math. 131:157-165 (1988). In the class number one CM setting this number should be asymptotic to a constant times M/(1n M)². In deriving this conjecture, Koblitz does not directly use twin primes in Q(\sqrt{−D}). It would be interesting to relate the Koblitz constant to the Gross-Smith β(D) in this restricted case of class number one.

An elliptic curve of j-value j₀ (mod p) found with the CM method is the reduction of an elliptic curve defined over the complex numbers having j-value associated with a corresponding root of the class polynomial H_{D}(x). The reduction is with respect to a prime lying above p in the algebraic number field in which the root lies. In the class number one case, the single root of H_{D} (x) is in Z. The corresponding elliptic curve is defined over Q, and the CM method amounts to reducing the equation of this curve modulo primes which split to principal ideals in Q(\sqrt{−D}). Thus, Koblitz's conjecture predicts the number of primes up to M (up to choosing twists) that give prime order elliptic curves.

Table 4 compares Koblitz predicted values, Gross-Smith twin primes values, and actual counts of twin primes and of anomalous primes. The anomalous values are primes naturally paired and are not counted as acceptable values of u. Whereas the Gross-Smith formula should give the number of twins, the Koblitz formula should give the number of twins plus half the number of the anomalous curves.

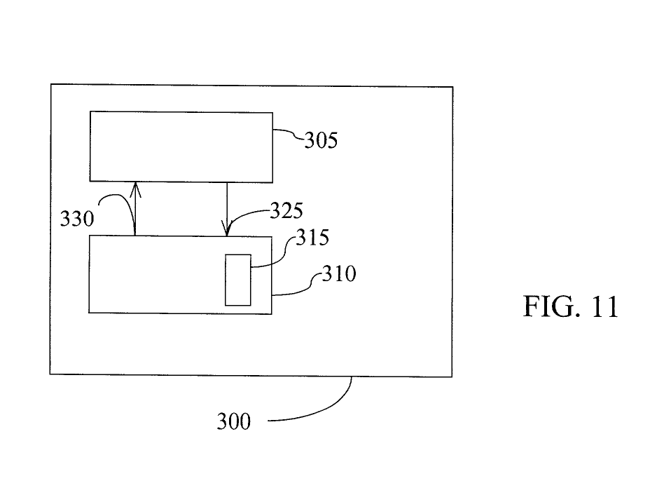

With reference to FIG. 11, a cryptographic processor 300 includes an elliptic curve generator 305 in communication with an elliptic curve processor 310. The elliptic curve generator includes a memory 315 configured to store a set of discriminant values and values associated with associated class polynomials. The generator includes an input 325 configured to receive an instruction from the processor to provide an elliptic curve and an output 330 for delivering a constructed elliptic curve. The processor 300 implements any of various elliptic curve procedures based on the constructed elliptic curve provided by the generator 305. Such a cryptographic processor can be included in various security applications, such as secure transaction servers used in, for example, financial transactions or medical records storage, SmartCards, and cell phones.

The elliptic curve generation methods provided can be implemented as computer instructions that can be stored on computer readable media such as RAM, ROM, floppy disks, hard disks, CD-ROMS. Discriminants and class polynomials can be stored to reduce processing delays.

Whereas the invention has been described in connection with several examples, it will be understood that the invention is not limited to these examples. On the contrary, the invention is intended to encompass all alternatives, modifications, and equivalents as may be included within the spirit and scope of the invention as defined by the appended claims.

TABLE 4
Twin primes: estimates and counts.

| D | M | Koblitz | Gross-Smith | Twins | Anomalous |
|---|---|---|---|---|---|
| 11 | 2000 | 10.9 | 12.1 | 12 | 4 |
| | 4000 | 17.9 | 19.2 | 20 | 4 |
| | 6000 | 24.1 | 25.5 | 23 | 5 |
| | 8000 | 30.1 | 31.3 | 26 | 5 |
| | 10000 | 35.7 | 36.7 | 33 | 5 |
| 19 | 2000 | 24.2 | 25.9 | 23 | 5 |
| | 4000 | 37.9 | 41.1 | 36 | 7 |
| | 6000 | 51.2 | 54.5 | 51 | 7 |
| | 8000 | 63.1 | 66.9 | 63 | 7 |
| | 10000 | 75.2 | 78.6 | 78 | 9 |
| 43 | 2000 | 41.7 | 46.1 | 45 | 4 |
| | 4000 | 67.1 | 73.2 | 72 | 5 |
| | 6000 | 89.2 | 97.0 | 88 | 5 |
| | 8000 | 111.1 | 119.0 | 105 | 6 |
| | 10000 | 131.5 | 139.9 | 122 | 7 |
| 67 | 2000 | 54.8 | 59.2 | 56 | 4 |
| | 4000 | 88.2 | 93.9 | 91 | 6 |
| | 6000 | 117.2 | 124.5 | 125 | 7 |
| | 8000 | 144.8 | 152.7 | 157 | 7 |
| | 10000 | 172.4 | 179.4 | 189 | 8 |
| 163 | 2000 | 76.6 | 94.3 | 72 | 4 |
| | 4000 | 128.9 | 149.6 | 127 | 5 |
| | 6000 | 180.0 | 198.3 | 183 | 6 |
| | 8000 | 225.4 | 243.3 | 234 | 6 |
| | 10000 | 265.4 | 285.8 | 272 | 6 |

We claim:

1. A method of generating an elliptic curve, comprising:
selecting a discriminant;
determining a class polynomial; and
constructing an elliptic curve based on the selected discriminant and class polynomial.

2. The method of claim 1, further comprising storing a set of discriminants and obtaining the selected discriminant from the set of discriminants.

3. The method of claim 2, further comprising storing a set of class polynomials and obtaining the selected class polynomial from the set of class polynomials.

4. The method of claim 1, further comprising storing a set of class polynomials and obtaining the selected class polynomial from the set of class polynomials.

5. The method of claim 1, further comprising adjusting an order of the constructed elliptic curve.

6. The method of claim 5, wherein the order of the elliptic curve is adjusted by forming a twist of the elliptic curve.

7. A computer readable medium that includes computer-readable instructions for performing the method of claim 6.

8. A computer readable medium that includes computer-readable instructions for performing the method of claim 1.

9. The method of claim 1, further comprising:
selecting a prime number based on the selected discriminant; and
determining an order of the constructed elliptic curve based on the prime number.

10. A cryptographic method, comprising:
requesting construction of an elliptic curve; and
providing an elliptic curve based on a selected discriminant.

11. A computer readable medium that includes computer-readable instructions for performing the method of claim 10.

12. The method of claim 10, further comprising obtaining a class polynomial, wherein the elliptic curve is based on a root of the class polynomial.

13. A cryptographic processor, comprising an elliptic curve generator configured to provide an elliptic curve based on a discriminant.

14. The processor of claim 13, further comprising discriminant memory configured to store a set of discriminants.

15. The processor of claim 14, further comprising a polynomial memory configured to store a set of class polynomials.

16. The processor of claim 15, wherein the elliptic curve generator is configured to generate the elliptic curve based on a stored discriminant and a stored class polynomial.

17. A cryptographic system, comprising a processor situated and configured to determine a set of discriminants and an associated set of class polynomials.

18. The system of claim 17, wherein the processor is configured to determine an order of an elliptic curve based on a selected discriminant of the set of discriminants.

19. An elliptic curve generator, comprising:
an input configured to receive an instruction to produce an elliptic curve;
a processor that constructs the elliptic curve based on a selected discriminant.

20. The elliptic curve generator of claim 19, wherein the processor is configured to receive the selected discriminant from a set of discriminants.

21. The elliptic curve generator of claim 20, further comprising a twist component that produces a twist of an elliptic curve.
